(19) United States
(12) Patent Application Publication
(10) Pub. No.: US 2025/0172930 A1
(43) Pub. Date: May 29, 2025

(54) METHOD AND APPARATUS FOR MONITORING A CYCLIC MANUFACTURING PROCESS

(71) Applicant: Kistler Holding AG, Winterthur (CH)

(72) Inventors: Gerrit Schatte, Winterthur (CH); Stefan Weber, Winterthur (CH); Mathias Schirmer, Kreuzlingen (CH); Thilo Stadelmann, Winterthur (CH); Matthias Rosenthal, Winterthur (CH); Simone Schwizer, Winterthur (CH); Damian Wildmann, Winterthur (CH); Peng YAN, Winterthur (CH); Ahmed Abdulkadir, Winterthur (CH); Robert Vaculik, Konstanz (DE); Giulia Aguzzi, Zürich (CH)

(21) Appl. No.: 18/954,866

(22) Filed: Nov. 21, 2024

(30) Foreign Application Priority Data
Nov. 24, 2023 (EP) 23212020.4

(51) Int. Cl. G05B 23/02; B29C 45/76

(52) U.S. Cl. CPC G05B 23/0254; B29C 45/762; B29C 2945/76006; B29C 2945/76257; B29C 2945/76949

(57) ABSTRACT

A method for monitoring a cyclic manufacturing process in which at least one piece good is manufactured in each cycle includes in a first process step for at least one cycle, at least one temporal sequence of sensor data of the manufacturing process, wherein the sensor data are in an effective relationship with a stability and an anomaly of the manufacturing process. In a second process step, the sensor data are marked as stable sensor data once the manufacturing process is determined to attain stability. In a third process step, the stable sensor data are reduced dimensionally to point data. In a fourth process step, a density distribution of the point data is formed with at least one stability area of the point data and at least one anomaly area of the point data that corresponds to an anomaly of the manufacturing process.

### FIELD OF THE INVENTION

The invention relates to a method and an apparatus for monitoring a cyclic manufacturing process with the aid of artificial intelligence.

### BACKGROUND OF THE INVENTION

A cyclical manufacturing process is characterized by repetitive activities in the production of piece goods. The activities are completed in cycles and then repeated. By repeating the activities in always the same way, a large number of identical piece goods can be produced, which keeps the manufacturing costs low. Examples of a cyclical manufacturing process are processes for primary forming such as casting, injection molding, sintering, etc. In the following, the invention is described with reference to an injection molding process, which does not exclude the use of the invention in other processes for primary forming.

In an injection molding process, piece goods are produced using an injection molding machine. For this purpose, each injection molding machine comprises an injection mold with at least one cavity. A material is injected into the cavity of the injection mold under pressure. The injected material plasticizes and assumes the shape of the cavity. The injected material cools down and forms a piece good. The injection molding process is monitored. The cavity pressure in the cavity of the injection mold is an important parameter for the quality of the piece good. Piece goods are good parts if they fulfill at least one quality characteristic during a quality inspection. Otherwise, the parts are bad parts. Anomalies in the injection molding process, such as a cavity pressure which is too high or too low, can lead to bad parts, which in turn increases manufacturing costs and has to be avoided.

Applicant's commonly owned WO2022/258239A1 discloses a method for determining anomalies in a cyclic manufacturing process such as an injection molding process. For each cycle, a temporal sequence of pressure values of the cavity pressure is reduced to at least one characteristic value, which characteristic value is automatically partitioned for several cycles in a decision tree. Assuming that good parts are very similar by nature, while bad parts are more different from each other, good parts cannot be partitioned in the decision tree as quickly as bad parts. The decision tree of good parts therefore has a comparatively greater depth. To determine anomalies in the injection molding process, the depth of the decision tree for a current cycle for a current characteristic value is then compared with the average depth of the decision tree for the same characteristic value from previous cycles. If the depth is lower, the current cycle shows an anomaly in the injection molding process.

### OBJECTS AND SUMMARY OF THE INVENTION

The object of present invention is to simplify and improve the method known from WO2022/258239A1 for monitoring a cyclic manufacturing process. A device for applying the simplified and improved method is also to be provided. In one embodiment, the method is applicable to an injection molding process that requires continuous monitoring of multiple sensors directed to gathering data from multiple components of the injection molding machinery, accounting for the time sequence of the data collected by each sensor and coordination of the data collected by such sensors in light of the time sequencing of data collection.

This object is solved by the features described hereinafter.

The invention relates to a method for monitoring a cyclic manufacturing process with several cycles, in which at least one piece good is produced in each cycle. In one embodiment, the method includes receiving, by a computing system, a temporal sequence of sensor data associated with a production machine performing the cyclic production process for at least one product during a first cycle, wherein a plurality of parameters of the production machine are set according to current machine setting data. In another step of this embodiment of the method, production point data is generated by the computing system based on the temporal sequence of sensor data associated with an injection mold machine performing the cyclic production process of at least one product during a first cycle. In a further step of the method, the computing system is used to compare the production point data to a mean value of stability to generate a stability value for the first cycle, wherein the mean value of stability is determined based on an evaluation of previous cycles of the cyclic production process and a stability value represents a likelihood of errors in the at least one product produced during the first cycle. In an additional step of the method, in accordance with a determination that the stability value does not exceed a threshold stability value, instructions are transmitted to the injection molding machinery to update at least one setting parameter of the production machine before performing a second cycle of the cyclic production process.

Additionally, in accordance with a determination that the stability value does not exceed a threshold stability value, the method can include the step of providing, by the computing system, current process parameter data to an error determining model. The method also can include the step of receiving, by the computing system as output from the error determining model, an error class associated with the first cycle.

The sensor data desirably is produced by one or more pressure sensors that are monitoring one or more regions of the production machine. Production point data desirably is generated using a machine-learned model that desirably employs an artificial intelligence protocol. The machine-learned model desirably is trained using training data labeled based on an inspection of the products produced by one or more previous production cycles and the sensor data associated with the one or more previous cycles. The training data desirably is labeled based on an inspection of the products produced by the previous production cycle and includes process parameter data for each previous production cycle. Moreover, the training data desirably further comprises temporal sequences of sensor data previously designated as stable and temporal sequences of sensor data designated as anomalous.

The method desirably includes generating, by the computing system, stability point data for the temporal sequences of data previously designated as stable by dimensionally reducing temporal sequences of database previously designated as stable. This step desirably is followed by the step of generating, by the computing system, a density distribution of the stability point data. Additionally, the method can include the step of performing, by the computing system, a statistical analysis of the stability point data to determine a mean value of stability.

The step of comparing, by the computing system, the production point data to a mean value of stability to generate a stability value for the first cycle, desirably includes the step of calculating, by the computing system, a distance between the production point data and the mean value of stability. And this step then is desirably followed by the step of generating, by the computing system, the stability value based on the distance between the production point data and the mean value of stability.

The process parameter data desirably describes one or more attributes of a production cycle including one or more of a maximum cavity pressure, an integral of a cavity pressure curve, and point data. Additionally, the current machine setting data and the process parameter data desirably is provided by the computing system to a machine-learned model as input. Moreover, the method desirably includes receiving, by the computing system, model output from the machine-learned model, wherein the model input includes an effect relationship between the current machine setting data and the process parameter data.

The step of transmitting instructions to update at least one setting parameter of the production machine before performing a second cycle of the cyclic production process also can include the step of determining, by the computing system, based on the current process parameter data and the effect relationship between the current machine setting data and the process parameter data, at least one planned setting parameter change.

The method desirably is applied to an injection molding machine that includes at least one injection device with a screw and at least one injection mold with at least one cavity. And such injection molding machine desirably performs according to at least an injection phase, followed by a holding pressure phase, and followed by a residual cooling phase. Moreover, the at least one setting parameter of the method desirably includes one of: a metering speed of the screw of an injection device, an injection speed of a melt into the cavity of the injection mold, a switchover time from the injection phase to the holding pressure phase, a relief movement of the screw of the injection device, a setpoint value of the holding pressure in the holding pressure phase, a temperature of the melt, and a temperature of the injection mold. Accordingly, in one embodiment of the method, there desirably can be included the step of determining, by the computing system, a cavity pressure curve based on the temporal sequence of sensor data associated with an injection molding machine performing the cyclic production process of at least one product during a first cycle.

In a first process step for an alternative embodiment of the method, at least one cycle at least one temporal sequence of sensor data of the manufacturing process is automatically provided, which sensor data are in an effective relationship with a stability and an anomaly of the manufacturing process; wherein in a second process step the stability of the manufacturing process is determined for the cycle, and the sensor data are marked as stable sensor data if the manufacturing process is stable; wherein in a third process step the stable sensor data are dimensionally reduced to point data in an automatic manner; and wherein in a fourth process step a density distribution of the point data is automatically formed, which density distribution has at least one stability area of the point data and at least one anomaly area of the point data, and which point data in the anomaly area correspond to an anomaly of the manufacturing process.

The invention also relates to a device for carrying out a method for monitoring a cyclic manufacturing process with several cycles, which device produces at least one piece good in each cycle; which device comprises at least one sensor unit, which sensor unit generates and automatically provides at least one temporal sequence of sensor data for executing a first process step for at least one cycle, which sensor data are in an effect relationship with a stability and an anomaly of the manufacturing process; which device comprises at least one evaluation unit, in which evaluation unit a computer program is loaded, which loaded computer program causes the evaluation unit to automatically load the sensor data; wherein the loaded computer program for executing the second process step causes the evaluation unit to mark the sensor data as stable sensor data when the stability of the manufacturing process has been determined; wherein the loaded computer program for executing a third process step causes the evaluation unit to dimensionally reduce the stable sensor data to point data in an automatic manner; and wherein the loaded computer program for executing a fourth process step causes the evaluation unit to automatically form a density distribution with the point data, which density distribution comprises at least one stability area of the point data and at least one anomaly area of the point data, and which point data in the anomaly area correspond to an anomaly of the manufacturing process.

In contrast to the teaching of document WO2022/258239A1, the present invention thus chooses a different approach. Instead of using the depth of decision trees of characteristic values to infer anomalies of the manufacturing process, when the stability of the manufacturing process is determined, the sensor data of the manufacturing process are marked as stable sensor data and dimensionally reduced to point data, which point data are then divided into a stability area and an anomaly area in a density distribution. The density distribution is a frequency distribution known from mathematical statistics. The density distribution indicates how densely the point data is distributed around a mean value of the point data. Point data that are close to the mean value are in the stability area. On the other hand, point data that are away from the mean value are in the anomaly area. The advantage of the invention resides in the fact that as soon as a stability area and an anomaly area of the point data are formed, further sensor data can be reduced to point data in a further cycle without determining the stability of the manufacturing process and without marking as stable sensor data and it can be determined solely from their position in the stability area or anomaly area whether an anomaly has occurred during the manufacture of the further piece good. The dimensional reduction of sensor data is carried out automatically, quickly and easily without a great deal of computing effort. The formation of the density distribution also does not require a great deal of computing effort and is also carried out automatically, simply and quickly. The method can therefore be integrated cost-effectively into existing cyclical manufacturing processes and provides a real-time prediction of the quality of the manufactured piece goods without having to check in a separate process step whether the piece goods meet a quality criterion or not, which saves effort and costs.

Further embodiments of the object of the invention are described below.

### BRIEF DESCRIPTION OF THE DRAWINGS

In the following, the invention is explained in more detail by way of example with reference to the figures.

FIG. 1 schematically shows a part of an injection molding machine 1 for monitoring a cyclical manufacturing process;

FIG. 2 shows three cavity pressure curves Y1, Y2, Y3 of a cyclical manufacturing process carried out with the injection molding machine 1 according to FIG. 1;

FIG. 3 shows a flow chart with several process steps M1 to M7 of method M for monitoring a cyclic manufacturing process using the injection molding machine 1 according to FIG. 1;

FIG. 4 shows a representation of a dimensional reduction and the determination of a stability area SA and an anomaly area AA of process steps M3 and M4 of said method M according to FIG. 3;

FIG. 5 shows a flow chart with several process steps M8 to M13 of said method M for monitoring a cyclic manufacturing process using the injection molding machine 1 according to FIG. 1;

FIG. 6 shows an illustration of the determination of an effect relationship R between machine setting data MPD and process parameter data PPD in method M9 of said method M according to FIG. 5;

FIG. 7 shows a representation of the determination of stable machine setting data SMPD and abnormal machine setting data AMPD in process step M11 of said method M according to FIG. 5;

FIG. 8 shows a representation of the order of residuals RE according to size SZ and sign SI in process step M13 of said method M according to FIG. 5; and

FIG. 9 shows a flow chart with several process steps M14 to M19 of said method M for monitoring a cyclic manufacturing process using the injection molding machine 1 according to FIG. 1.

Identical reference numerals denote identical objects in the figures.

### DETAILED DESCRIPTION OF EXEMPLARY EMBODIMENTS OF THE INVENTION

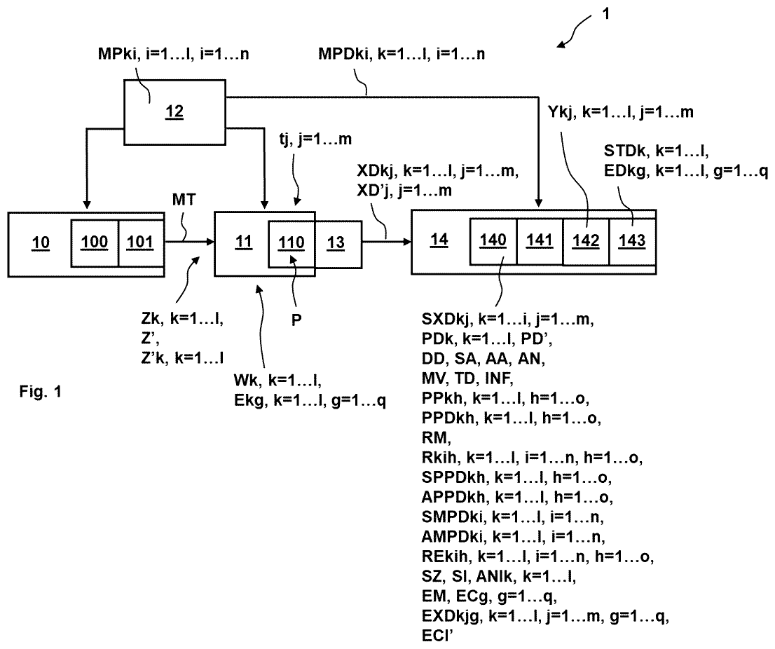

FIG. 1 schematically shows a part of an injection molding machine 1 for monitoring an injection molding process, which is commercially available and known to the person skilled in the art. The injection molding process is an example of a cyclical manufacturing process. The manufacturing process is characterized by repeated activities in several cycles Z. A piece good W is produced in each cycle Z. The cycle Z and the piece good W are also represented with a cycle index k as Zk, k=1 . . . I and Wk, k=1 . . . I. The cycle index k denotes the individual cycles Z and the cycle number I denotes the number of cycles Z. For a cycle duration of 10 seconds, which is typical for an injection molding process, 6240 piece goods W are produced in 24 hours of continuous operation of the injection molding machine 1.

Each cycle Zk, k=1 . . . I exhibits phases I to III. The first phase I is also called injection phase I. The second phase II is also called holding pressure phase II. The third phase III is also called residual cooling phase III.

The injection molding machine 1 comprises as a component at least one injection device 10 with a screw 100 and a nozzle 101. The screw 100 is used to liquefy a material into a melt MT and move it towards said nozzle 101. The melt MT can be made of plastic, metal, ceramic, etc.

Furthermore, the injection molding machine 1 comprises at least one injection mold 11 with at least one cavity 110 as a component. In said injection phase I, the melt MT is injected under pressure through the nozzle 101 into the cavity 110. In the holding pressure phase II, the melt MT injected into the injection mold 11 is caused to solidify in the cavity 110. In the residual cooling phase III, the largely solidified melt MT cools down in the cavity 110. At the end of the manufacturing process, a finished piece good Wk, k=1 . . . I is ejected from the cavity 110.

The injection molding machine 1 comprises at least one control unit 12 as a component. The control unit 12 controls the injection molding process via at least one machine setting parameter MP. The machine setting parameter MP is also represented by the cycle index k and a machine setting parameter index i as MPki, k=1 . . . I, i=1 . . . n. The machine setting parameter index i denotes the individual machine setting parameters MPki, k=1 . . . I, i=1 . . . n and the machine setting parameter number n denotes the number of machine setting parameters MPki, k=1 . . . I, i=1 . . . n. Specifically, the machine setting parameter is MPki, k=1 . . . I, i=1 . . . n:
a first machine setting parameter MPki, k=1 . . . I, i=1 is a metering speed of the screw 100.
a second machine setting parameter MPki, k=1 . . . I, i=2 is an injection speed of the melt MT into the cavity 110.
a third machine setting parameter MPki, k=1 . . . I, i=3 is a switchover time tII from injection phase I to holding pressure phase II.
a fourth machine setting parameter MPki, k=1 . . . I, i=4 is a relief movement of the screw 100.
a fifth machine setting parameter MPki, k=1 . . . I, i=5 is a setpoint value of the holding pressure in holding pressure phase II.
a sixth machine setting parameter MPki, k=1 . . . I, i=6 is a temperature of the melt MT.
a seventh machine setting parameter MPki, k=1 . . . I, i=7 is a temperature of the injection mold 11.

The control unit 12 generates machine setting data MPD for the machine setting parameters MPki, k=1 . . . I, i=1 . . . n. The machine setting data MPD is also displayed with the cycle index k and the machine setting parameter index i as MPDki, k=1 . . . I, i=1 . . . n. The machine setting data MPDki, k=1 . . . I, i=1 . . . n are digital data.

The injection molding machine 1 comprises at least one sensor unit 13 as a component. The sensor unit 13 is arranged at the cavity 110. The sensor unit 13 can be a pressure sensor, a temperature sensor, etc. Preferably, said sensor unit 13 is a pressure sensor which measures a time course of an cavity pressure P in the cavity 110. The pressure sensor may be a piezoelectric pressure sensor, a piezoresistive pressure sensor, etc. Preferably, the pressure sensor is a piezoelectric pressure sensor which is electrically connected to an amplifier unit. The piezoelectric pressure sensor and the amplifier unit generate a temporal sequence of sensor data XD for the measured temporal progression of the cavity pressure P. Said sensor data XD are digital data. The sensor data XD are also represented with the cycle index k and a sensor data index j as XDkj, k=1 . . . I, j=1 . . . m. The sensor data index j denotes the individual sensor data XDkj, k=1 . . . I, j=1 . . . m and the sensor data number m denotes the number of sensor data XDkj, k=1 . . . I, j=1 . . . m. The sensor data XDkj, k=1 . . . I, j=1 . . . m follow one another in time at times tj, j=1 . . . m and are preferably at a constant time interval from one another. The piezoelectric pressure sensor measures the cavity pressure P as electrical polarization charges. A single sensor data element XDkj, k=1 . . . I, j=1 . . . m denotes a quantity of electrical polarization charges at a time tj, j=1 . . . m. The quantity of electrical polarization charges is proportional to the size of the cavity pressure P. The piezoelectric pressure sensor typically measures the cavity pressure P with a measurement accuracy of 1%. The piezoelectric pressure sensor measures the cavity pressure P with a temporal resolution of 0.01 Hz or less. For an injection molding process with a typical cycle duration of 10 seconds, the piezoelectric pressure sensor thus measures the cavity pressure P at least 1000 times and generates a temporal sequence of at least 1000 sensor data XDkj, k=1 . . . I, j=1 . . . m.

The injection molding machine 1 comprises at least one evaluation unit 14 as a component. The evaluation unit 14 comprises at least one data processor 140, at least one data memory 141, at least one output unit 142 and at least one input unit 143. At least one computer program CP is stored in the data memory 141 and can be loaded into the data processor 140. The evaluation unit 14 is connected to the control unit 12 and the sensor unit 13 via signal lines. The evaluation unit 14 receives the machine setting data MPDki, k=1 . . . I, i=1 . . . n from the control unit 12 via the signal lines and it receives the temporal sequences of sensor data XDkj, k=1 . . . I, j=1 . . . m from said sensor unit 13.

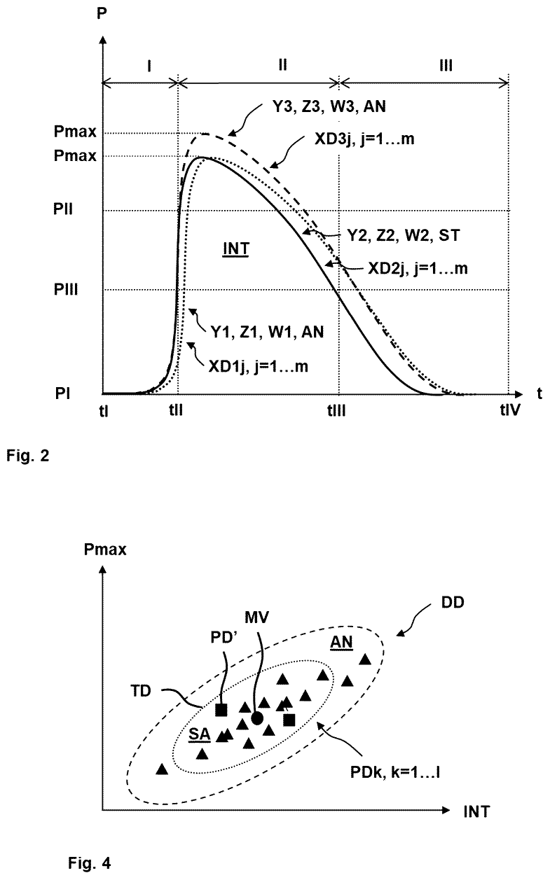

The computer program CP loaded into the data processor 140 causes the evaluation unit 14 to load a temporal sequence of sensor data XDkj, k=1 . . . I, j=1 . . . m of cycles Zk, k=1 . . . I into the data processor 140 and to evaluate the loaded sensor data XDkj, k=1 . . . I, j-1 . . . m. A first evaluation result of the sensor data XDkj, k=1 . . . I, j=1 . . . m is the determination of at least one cavity pressure curve Yk, k=1 . . . I, which can be seen in FIG. 2. The cavity pressure curve Yk, k=1 . . . I can be displayed on the output unit 142. Preferably, the output unit 142 is a screen, so that an operator of the injection molding machine 1 is aware of the cavity pressure curve Yk, k=1 . . . I displayed on the screen. The display of the cavity pressure curve Yk, k=1 . . . I exhibits an ordinate and an abscissa. The ordinate denotes the cavity pressure P, the ordinate denotes the time t. The area underneath of the cavity pressure curve Yk, k=1 . . . I is called integral INT.

The injection molding process is explained below using the cavity pressure curve Yk, k=1 . . . I.

The injection phase I begins at a time tI with an initial cavity pressure PI and ends at a time tII with a filling pressure PII. In the injection phase I, the injection device 10 liquefies material to a melt MT and presses the melt MT with the screw 100 against the nozzle 101. The melt MT is injected through said nozzle 101 into the cavity 110 of the injection mold 11. The higher the injection speed, the faster the cavity 110 is filled with melt MT. When the cavity 110 is filled with melt MT, the cavity pressure P rises to a maximum cavity pressure Pmax in a short period of time. Shortly before the maximum cavity pressure Pmax is detected, the cavity 110 is completely filled with melt MT and the filling pressure PII is measured. The time tII at which the cavity is completely filled with melt is the switchover time tII. Injection phase I is complete.

The holding pressure phase II begins at the switchover time tII. During said holding pressure phase II, the injection device 10 exerts a holding pressure onto the melt MT in the cavity 110 at the nozzle 101. Shrinkage of the cooling melt MT is also compensated for by further melt MT flowing into the cavity 110. The screw 100 performs a relief movement. The holding pressure influences a level of the cavity pressure P, particularly in the area of the maximum cavity pressure Pmax, where the melt MT is temporary compressed and the cavity pressure P is greater than the filling pressure PII. Thereby, control unit 12 reduces the cavity pressure P to a sealing point pressure PIII. Said melt MT is solidified in the cavity 110 and cools down in the process. The holding pressure phase II ends at a time tIII with the sealing point pressure PIII. The holding pressure time influences the speed at which the cavity pressure P drops.

At time tIII the residual cooling phase III begins, the solidified melt MT further cools down. Said time tIII is also designated as sealing point tIII, at which the melt MT in the area of the nozzle 101 of the injection device 10 has solidified to such an extent that no more melt MT can flow into the cavity 110, the cavity 110 is sealed. The injection mold 11 can be cooled by a coolant. The injection molding machine 1 can cool the mold temperature of the cavity 110 to a greater or lesser extent in holding pressure phase II and in residual cooling phase III. The residual cooling phase III ends at the time tIV, at which the finished piece good W is ejected from the cavity 110.

A further evaluation result of the sensor data XDkj, k=1 . . . I, j=1 . . . m is the determination of at least one process parameter PP, which can be taken from the cavity pressure curves Yk, k=1 . . . I. The process parameter PP is also represented with the cycle index k and a process parameter index m as PPkh, k=1 . . . I, h=1 . . .o. The process parameter index h denotes the individual process parameters PPkh, k=1 . . . I, h=1 . . . o and the process parameter number o denotes the number of process parameters PPkh, k=1 . . . I, h=1 . . . o. Specifically, the process parameter PPkh, k=1 . . . I, h=1 . . . o is:
A first process parameter PPkh, k=1 . . . I, h=1 is the maximum cavity pressure Pmax.
A second process parameter PPkh, k=1 . . . I, h=2 is the integral INT of the cavity pressure curve Yk, k=1 . . . I.
A third process parameter PPkh, k=1 . . . I, h=3 is the point data PDk, k=1 . . . I described below.

FIG. 2 shows three cavity pressure curves Yk, k=1 . . . 3 of three cycles Zk, k=1 . . . 3 in the production of three piece goods Wk, k=1 . . . 3. The first cavity pressure curve Y1 is shown as a dotted line. The second cavity pressure curve Y2 is shown as a solid line. The third cavity pressure curve Y2 is shown as a broken line. The three cavity pressure curves Yk, k=1 . . . 3 differ from each other in shape. Thus, the first cavity pressure curve Y1 shows a slower increase in pressure when filling the cavity 110 than the second and third cavity pressure curves Y2, Y3. The third cavity pressure curve Y3 also exhibits a greater maximum cavity pressure Pmax than the first two cavity pressure curves Y1, Y2. And the third cavity pressure curve Y3 has a greater integral INT than the first two cavity pressure curves Y1, Y2.

The shape of the first cavity pressure curve Y1 with a comparatively slow increase in pressure when filling the cavity 110 is an indication of an anomaly AN during the manufacturing process. And the shape of the third cavity pressure curve Y3 with a comparatively large maximum cavity pressure Pmax is also an indication of an anomaly AN in the manufacturing process. The shape of the third cavity pressure curve Y3 with a comparatively large integral INT also indicates an anomaly AN in the manufacturing process. Only the shape of the second cavity pressure curve Y3 with a pressure increase which is comparatively not slow, a maximum cavity pressure Pmax which is comparatively not too high and an integral INT which is comparatively not too high indicates stability ST during the manufacturing process.

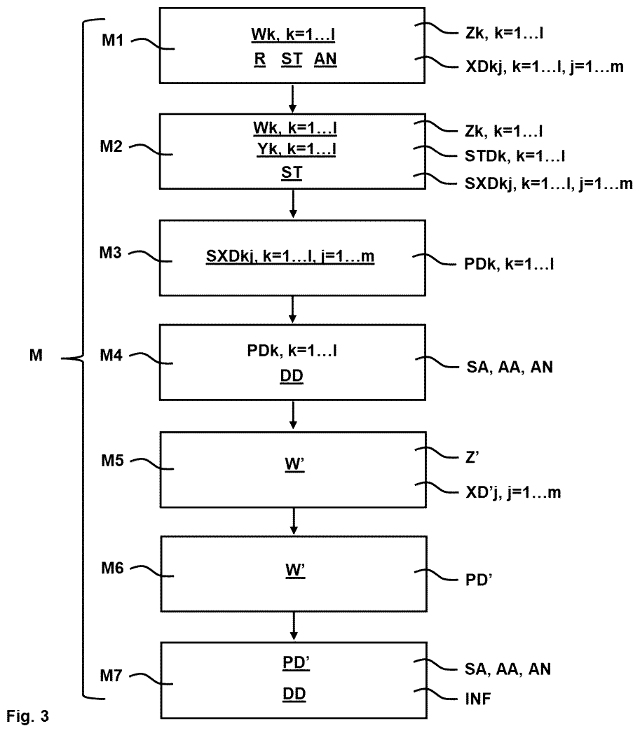

FIG. 3 shows a flow chart with several process steps M1 to M7 of the method M for monitoring a cyclic manufacturing process with several cycles Zk, k=1 . . . I, where at least one piece good Wk, k=1 . . . I is produced in each cycle Zk, k=1 . . . I.

In a first process step M1, at least one temporal sequence of sensor data XDkj, k=1 . . . I, j=1 . . . m of the manufacturing process is automatically provided for each cycle Zk, k=1 . . . I, j=1 . . . m, which sensor data XDkj, k=1 . . . I, j=1 . . . m are in an effective relationship R with the stability ST and the anomaly AN of the manufacturing process. If the manufacturing process exhibits stability ST, the piece good Wk, k=1 . . . I is free of defects. With anomaly AN of the manufacturing process, the piece good Wk, k=1 . . . I is not free of defects. To carry out the first process step M1, the sensor data XDkj, k=1 . . . I, j=1 . . . m are generated by the sensor unit 13. The provision of the sensor data XDkj, k=1 . . . I, j=1 . . . m takes place automatically in the evaluation unit 14. The computer program CP loaded into the data processor 140 causes the evaluation unit 14 to automatically load the sensor data XDkj, k=1 . . . I, j=1 . . . m into the data processor 140. For the purposes of the present invention, “automatically” means that the components of the injection molding machine 1 perform an action in an automatic manner, without the intervention of an operator of the injection molding machine 1.

In a second process step M2, the stability ST of the manufacturing process is determined for each cycle Zk, k=1 . . . I. Preferably, the operator of the injection molding machine 1 carries out the determination of the stability ST of the manufacturing process. For this purpose the operator has a variety of options. For example, the operator can visually inspect a part Wk, k=1 . . . I produced in a cycle Zk, k=1 . . . I and determine whether the part Wk, k=1 . . . I is free of defects. The operator can also visually check a cavity pressure curve Yk, k=1 . . . I displayed on the output unit 142 and use the shape of the cavity pressure curve Yk, k=1 . . . I to determine an indication of the stability ST of the manufacturing process.

When stability ST of the manufacturing process is reached, the operator of the injection molding machine 1 generates stability confirmation data STDk, k=1 . . . I. The stability confirmation data STDk, k=1 . . . I are digital data. The stability confirmation data STDk, k=1 . . . I can be generated in a variety of ways. For example, the operator can enter stability confirmation data STDk, k=1 . . . I into the evaluation unit 14 via the input unit 143. The input unit 143 is a keyboard, a touch-sensitive screen, etc. The operator can press a combination of keys on the keyboard to enter the stability confirmation data STDk, k=1 . . . I, or he/she can touch a certain area of the touch-sensitive screen.

The computer program CP loaded into the data processor 140 causes the evaluation unit 14 to automatically load the stability confirmation data STDk, k=1 . . . I into the data processor 140 and to mark the sensor data XDkj, k=1 . . . I, j=1 . . . m as stable sensor data SXDkj, k=1 . . . I, j=1 . . . m when the manufacturing process exhibits stability ST.

In a third process step M3, the stable sensor data SXDkj, k=1 . . . I, j=1 . . . m are dimensionally reduced to point data PDK, k=1 . . . I in an automatic manner. The dimensional reduction automatically takes place in the evaluation unit 14. The computer program CP loaded into the data processor 140 causes the evaluation unit 14 to project the stable sensor data SXDkj, k=1 . . . I, j=1 . . . m into a space with at least two principal component axes. The two principal component axes are the result of the calculation of a neural network or the directions of the largest scatter of the stable sensor data SXDkj, k=1 . . . I, j=1 . . . m. The projection result is the point data PDk, k=1 . . . I. The dimensional reduction can be displayed for the operator of the injection molding machine 1 on the output unit 142, which can be seen in FIG. 4. The two principal component axes are plotted as an ordinate and an abscissa. The ordinate denotes the first principal component, the first process parameter PPkh, k=1 . . . I, h=1, i.e. the maximum cavity pressure Pmax. The abscissa denotes the second principal component, the second process parameter PPkh, k=1 . . . I, h=2, i.e. the integral INT of the cavity pressure curve Yk, k=1 . . . I. The point data PDk, k=1 . . . I are shown as triangles.

In a fourth process step M4, a density distribution DD of the point data PDk, k=1 . . . I is automatically formed. The formation of the density distribution DD is performed automatically in the evaluation unit 14. The computer program CP loaded into the data processor 140 causes the evaluation unit 14 to automatically load said point data PDK, k=1 . . . I into the data processor 140 and to form the density distribution DD using the point data PDk, k=1 . . . I. The density distribution DD has at least one stable area SA of the point data PDk, k=1 . . . I and at least one anomaly area AA of the point data PDK, k=1 . . . I. The density distribution is a frequency distribution known from mathematical statistics. The density distribution indicates how densely the point data PDk, k=1 . . . I are distributed around a mean value MV of the point data. Point data PDk, k=1 . . . I, which are close to the mean value MV, are in the stability area SA. On the other hand, point data PDk, k=1 . . . I, which are away from the mean value MV, are in the anomaly area AA. The mean value MV can be determined in a variety of ways. For example, the mean value MV can be an arithmetic mean value, a geometric mean value, etc. However, the mean value MV can also be the value of the point data PDk, k=1 . . . I that corresponds with a high degree of probability to a manufacturing process with stability ST. Point data PDk, k=1 . . . I in the anomaly area AA correspond to an anomaly AN of the manufacturing process.

The density distribution DD can be displayed for the operator of the injection molding machine 1 on the output unit 142, which can be seen in FIG. 4. The density distribution DD is marked as a dashed ellipse. The density distribution DD exhibits a mean value MV of the point data PDk, k=1 . . . I. The mean value MV is marked as a black circle. The spatial distribution of the point data PDk, k=1 . . . I is densest in the area around the mean value MV. The density distribution DD has a threshold distance TD to the mean value MV. The threshold distance TD is marked as an ellipse with dotted lines. Point data PDk, k=1 . . . I, which lie outside the threshold distance TD to the mean value MV, correspond to an anomaly AN of the manufacturing process. The threshold distance TD can be determined in a variety of ways. For example, the threshold distance TD can be an Euclidean distance, a Mahalanobis distance, etc.

In a fifth process step M5, at least one temporal sequence of additional sensor data XD′j, j=1 . . . m of the manufacturing process of a further piece good W′ is automatically provided for a further cycle Z′. The additional sensor data XD′j, j=1 . . . m are generated by said sensor unit 13 and are automatically provided to the evaluation unit 14. The computer program CP loaded into the data processor 140 causes the evaluation unit 14 to load the additional sensor data XD′j, j=1 . . . m into said data processor 140.

In a sixth process step M6, the temporal sequence of additional sensor data XD′j, j=1 . . . m of the further piece goods W′ is dimensionally reduced to additional point data PD′ in an automatic manner. The computer program CP loaded into the data processor 140 causes the evaluation unit 14 to project the additional sensor data X′Dj, j=1 . . . m into the space with at least two principal component axes. This is already described in the third process step M3 and shown in FIG. 4. The additional point data PD′ are shown as squares.

In a seventh process step M7, it is automatically determined whether the additional point data PD′ are located in the stability area SA or whether the additional point data PD′ are located in the anomaly area AA. The determination of the position of the additional point data PD′ in the stability area SA or in the anomaly area AA is carried out by said evaluation unit 14 and is initiated by the computer program CP loaded into the data processor 140. In FIG. 4, the additional point data PD′ are located in the stability area SA. The evaluation unit 14 generates process information PI, which indicates whether stability ST or anomaly AN is present in the manufacturing process of the other piece goods W′.

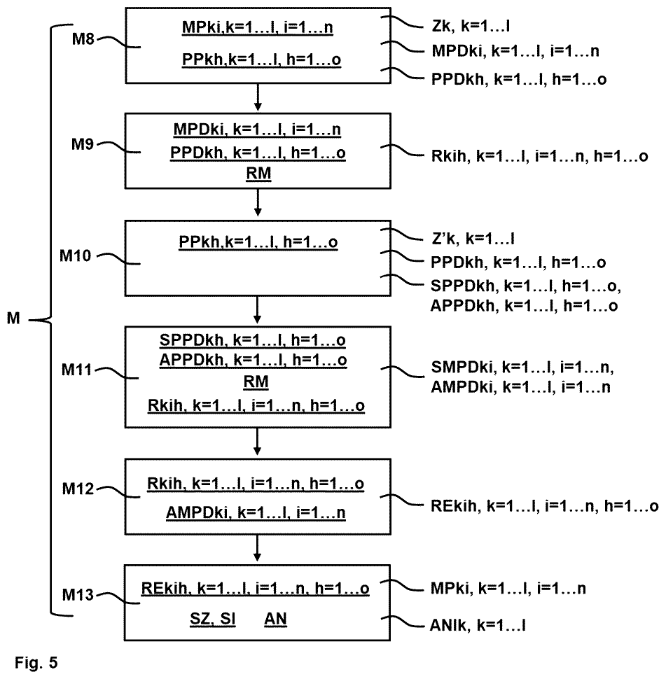

FIG. 5 shows a flow chart with several process steps M8 to M13 of the method M for monitoring a cyclic manufacturing process with several cycles Zk, k=1 . . . I, where at least one piece good Wk, k=1 . . . I is produced in each cycle Zk, k=1 . . . I.

In an eighth process step M8, in several cycles Zk, k=1 . . . I in each cycle Zk, k=1 . . . I at least one machine setting parameter MPki, k=1 . . . I, i=1 . . . n is varied and machine setting data MPDki, k=1 . . . I, i=1 . . . n of the machine setting parameter variation are provided for each cycle Zk, k=1 . . . I, i=1 . . . n of the machine setting parameter variation. The eighth process step M8 is carried out by the control unit 12, which provides the evaluation unit 14 with machine setting data MPDki, k=1 . . . I, i=1 . . . n of the machine setting parameter variation for each cycle Zk, k=1 . . . I, i=1 . . . n of the machine setting parameter variation.

Process parameters PPkh, k=1 . . . I, h=1 . . . o of the machine setting parameter variation are also determined for each cycle Zk, k=1 . . . I, h=1 . . . o of the machine setting parameter variation and process parameter data PPDkh, k=1 . . . I, h=1 . . . o are provided for the determined process parameters PPkh, k=1 . . . I, h=1 . . . o. The determination of the process parameters PPkh, k=1 . . . I, h=1 . . . o and the provision of the process parameter data PPDkh, k=1 . . . I, h=1 . . . o, which

represent additional principal component directions according to section [0038], is automatically carried out by the evaluation unit 14 and is initiated by the computer program CP loaded into the data processor 140.

In a ninth process step M9, a regression model RM is provided, into which regression model RM the machine setting data MPDki, k=1 . . . I, i=1 . . . n and the process parameter data PPDkh, k=1 . . . I, h=1 . . . o are automatically entered. The regression model RM determines an effect relationship Rkih, k=1 . . . I, i=1 . . . n, h=1 . . . o between the machine setting data MPDki, k=1 . . . I, i=1 . . . n and the process parameter data PPDkh, k=1 . . . I, h=1 . . . o. The execution of the ninth process step M9 by the evaluation unit 14 is initiated by the computer program CP loaded into the data processor 140. If only a single combination of machine setting parameters MPki, k=1 . . . I, i=1 . . . n is provided over several cycles Zk, k=1 . . . I (no variation of the parameters), a point calibration is performed in which only the mean value and the standard deviation of the process parameter data PPDkh, k=1 . . . I, h=1 . . . o. are determined.

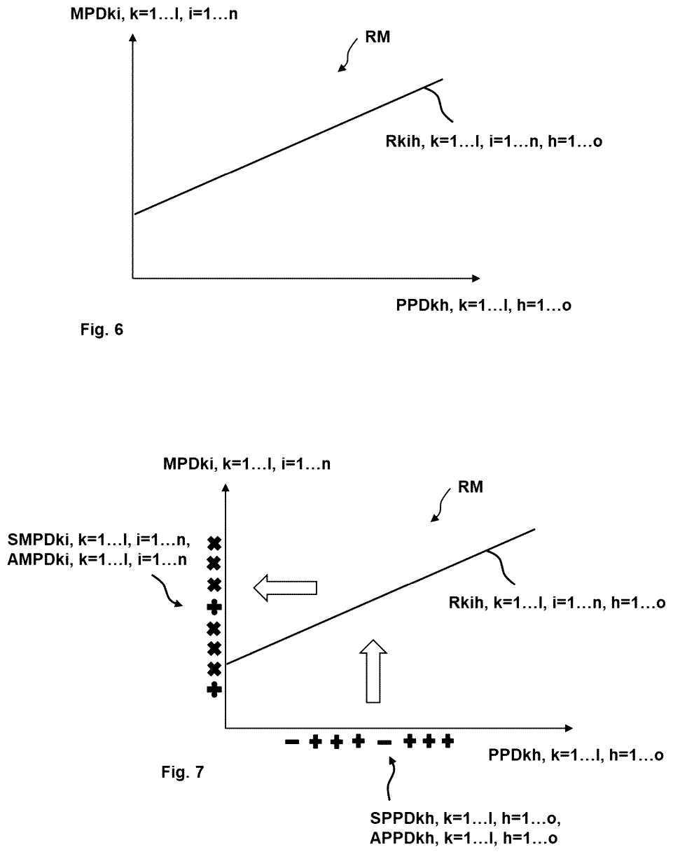

FIG. 6 shows a graphical representation of the determination of the effect relationship Rkih, k=1 . . . I, i=1 . . . n, h=1 . . . 0. The machine setting data MPDki, k=1 . . . I, i=1 . . . n are plotted on the ordinate, process parameter data PPDkh, k=1 . . . I, h=1 . . . o are plotted on the abscissa. Using the method of least squares, the effect relationship Rkih, k=1 . . . I, i=1 . . . n and the process parameter data PPDkh, k=1 . . . I, h=1 . . . o are determined between the machine setting data MPDki, k=1 . . . I, i=1 . . . n, h=1 . . . 0. Preferably, the regression model RM is a multivariate regression model with several independent variables and several dependent variables, which are in a largely linear relationship to each other. In the case of a point calibration, the mean value PPDkhM of the calibration and its standard deviation are determined in a simplified manner as the effect relationship.

In a tenth process step M10, process parameters PPkh, k=1 . . . I, h=1 . . . o are determined for several further cycles Z′k, k=1 . . . I and process parameter data PPDkh, k=1 . . . I, h=1 . . . o are provided for the determined process parameters PPkh, k=1 . . . I, h=1 . . . o. The determination of the process parameters PPkh, k=1 . . . I, h=1 . . . o and the provision of the process parameter data PPDkh, k=1 . . . I, h=1 . . . o is automatically carried out by the evaluation unit 14 and is initiated by the computer program CP loaded into the data processor 140.

The stability ST of the manufacturing process is also determined in the tenth process step M10 for each further cycle Z′k, k=1 . . . I. Preferably, the operator of the injection molding machine 1 carries out the determination of the stability ST of the manufacturing process, which is already described in the second process step M2, to which reference is made. In the case of stability ST of the manufacturing process, the operator of the injection molding machine 1 generates stability confirmation data SDK, k=1 . . . I. This is also already described in the second process step M2, to which reference is made.

In the event of stability ST of the manufacturing process, the process parameter data PPDkh, k=1 . . . I, h=1 . . . o are automatically marked as stable process parameter data SPPDkh, k=1 . . . I, h=1 . . . o. In the event of an anomaly AN of the manufacturing process, the process parameter data PPDkh, k=1 . . . I, h=1 . . . o are automatically marked as abnormal process parameter data APPDkh, k=1 . . . I, h=1 . . . o. The marking of the sensor data XDkj, k=1 . . . I, j=1 . . . m in stable process parameter data SPPDkh, k=1 . . . I, h=1 . . . o or abnormal process parameter data APPDkh, k=1 . . . I, h=1 . . . o takes place in the evaluation unit 14 and is initiated by the computer program CP loaded in the data processor 140.

In an eleventh process step M11, the stable process parameter data SPPDkh, k=1 . . . I, h=1 . . . o and the abnormal process parameter data APPDkh, k=1 . . . I, h=1 . . . o are entered into the regression model RM and, and via the effect relationship Rkih, k=1 . . . I, i=1 . . . n, h=1 . . . o, stable machine setting data SMPDki, k=1 . . . I, i=1 . . . n corresponding to stable process parameter data SPPDkh, k=1 . . . I, h=1 . . . o and abnormal machine setting data AMPDki, k=1 . . . I, i=1 . . . n corresponding to abnormal process parameter data APPDkh, k=1 . . . I, h=1 . . . o are determined. The stable machine setting data SMPDki, k=1 . . . I, i=1 . . . n and the abnormal machine setting data AMPDki, k=1 . . . I, i=1 . . . n are also referred to as stable machine setting data SMPD and abnormal machine data AMPD without cycle index k and without machine setting parameter index i. The execution of the eleventh process step M11 by the evaluation unit 14 is initiated by the computer program CP loaded into the data processor 140.

FIG. 7 shows a graphical representation of the determination of the stable machine setting data SMPDki, k=1 . . . I, i=1 . . . n and the abnormal machine setting data AMPDki, k=1 . . . I, i=1 . . . n. Starting from the effect relationship Rkih, k=1 . . . I, i=1 . . . n, h=1 . . . 0 according to FIG. 6, the stable process parameter data SPPDkh, k=1 . . . I, h=1 . . . o and the abnormal process parameter data APPDkh, k=1 . . . I, h=1 . . . o are plotted on the abscissa. The corresponding stable machine setting data SMPDki, k=1 . . . I, i=1 . . . n, h=1 . . . 0 and the corresponding abnormal machine setting data AMPDki, k=1 . . . I, i=1 . . . n on the ordinate are determined via the effect relationship Rkih, k=1 . . . I, i=1 . . . n, h=1 . . . 0. The correspondence is shown by arrows.

In a twelfth process step M12, residuals REkih, k=1 . . . I, i=1 . . . n, h=1 . . . o of the abnormal machine setting data AMPDki, k=1 . . . I, i=1 . . . n are formed with respect to the effective relationship Rkih, k=1 . . . I, i=1 . . . n, h=1 . . . o. The residuals REkih, k=1 . . . I, i=1 . . . n, h=1 . . . o are the difference between the abnormal machine setting data AMPDki, k=1 . . . I, i=1 . . . n and the effect relationship Rkih, k=1 . . . I, i=1 . . . n, h=1 . . . o. The residuals REkih, k=1 . . . I, i=1 . . . n, h=1 . . . o are also referred to as residuals RE without cycle index k and without machine setting parameter index i and without process parameter index h. In the case of a point calibration, the deviation from the center point of the calibration is provided as a multiple of the determined standard deviation. This provides the operator of the injection molding machine 1 with information about the direction and amount of the deviation of the parameters in the event of an anomaly AN. The execution of the twelfth process step M12 by the evaluation unit 14 is initiated by the computer program CP loaded into the data processor 140.

In a thirteenth process step M13, the residuals REkih, k=1 . . . I, i=1 . . . n, h=1 . . . o are ordered according to size SZ and sign SI. The execution of the thirteenth process step M13 by the evaluation unit 14 is initiated by the computer program CP loaded into the data processor 140. The evaluation unit 14 generates anomaly information ANIk, k=1 . . . I, which indicates which machine setting parameters MPki, k=1 . . . I, i=1 . . . n, whose residuals REkih, k=1 . . . I, i=1 . . . n, h=1 . . . o are ordered highest according to size SZ and sign SI, are the cause of an anomaly AN of the manufacturing process. The anomaly information ANIk, k=1 . . . I is also referred to as ANI without cycle index k.

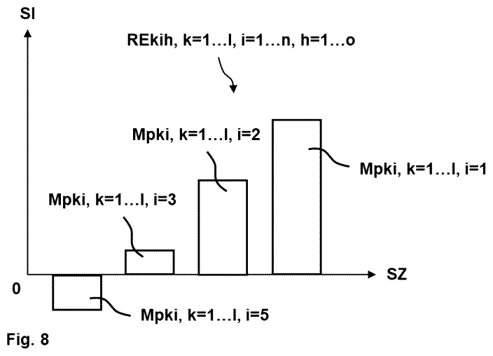

FIG. 8 shows a graphical representation of the order of residuals REkih, k=1 . . . I, i=1 . . . n, h=1 . . . o according to size SZ and sign SI. In the graph in FIG. 8, the size SZ is plotted on the abscissa and the sign SI on the ordinate. Four residuals REkih, k=1 . . . I, i=1 . . . n, h=1 . . . o are shown:
A residual REkih, k=1 . . . I, i=5, h=1 . . . o, which corresponds to the fifth machine parameter MPki, k=1 . . . I, i=5, i.e. the temperature of the melt MT, via the machine parameter index i=5, exhibits a negative sign SI and the comparatively smallest size SZ.
A residual REkih, k=1 . . . I, i-3, h=1 . . . o, which corresponds to the third machine setting parameter MPki, k=1 . . . I, i=3, i.e. the switchover time tII via the machine setting parameter index i=3, exhibits a positive sign SI and the comparatively second smallest size SZ.
A residual REkih, k=1 . . . I, i=2, h=1 . . . o, which corresponds to the second machine setting parameter MPki, k=1 . . . I, i=2, i.e. the injection speed of the melt MT into the cavity 110 via the machine setting parameter index i=2, exhibits a positive sign SI and the comparatively second-largest variable SZ.
A residual REkih, k=1 . . . I, i=1, h=1 . . . o, which corresponds to the first machine setting parameter MPki, k=1 . . . I, i=1, i.e. the dosing speed of the screw 100 via the machine setting parameter index i=1, exhibits a positive sign SI and the comparatively largest size SZ.

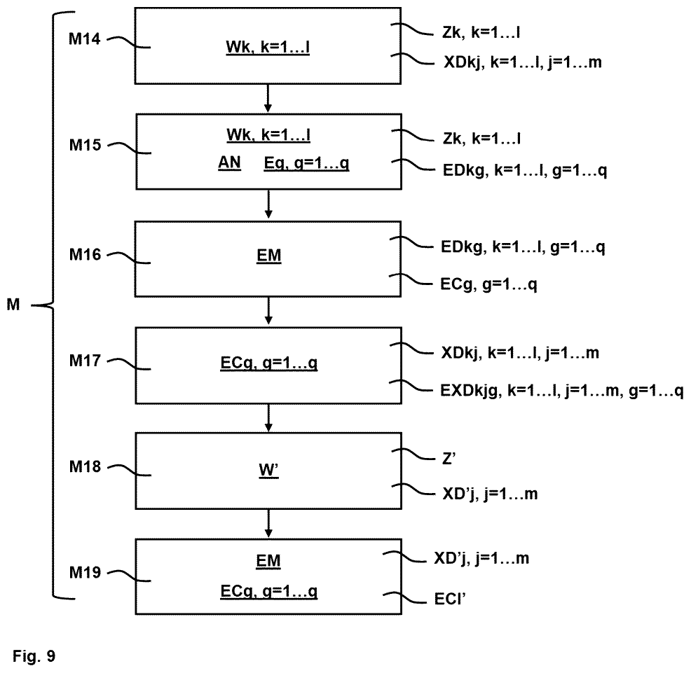

FIG. 9 shows a flow chart with several process steps M14 to M19 of the method M for monitoring a cyclic manufacturing process.

In a fourteenth process step M14, at least one piece good Wk, k=1 . . . I is produced in several cycles Zk, k=1 . . . I in each cycle Zk, k=1 . . . I and for each cycle Zk, k=1 . . . I at least one temporal sequence of sensor data XDkj, k=1 . . . I, j=1 . . . m of the manufacturing process is automatically provided. The provision of the sensor data XDkj, k=1 . . . I, j=1 . . . m takes place in the evaluation unit 14. The computer program CP loaded into the data processor 140 causes the evaluation unit 14 to load the sensor data XDkj, k=1 . . . I, j=1 . . . m into the data processor 140.

In a fifteenth process step M15, the stability ST or anomaly AN of the manufacturing process is determined for several cycles Zk, k=1 . . . I. At least one error E can be determined for anomaly AN of the manufacturing process. Preferably, several errors E are predefined. The error E is also represented with the cycle index k and an error index g as Ekg, k=1 . . . I, g=1 . . . q. The error index g denotes the individual errors Ekg, k=1 . . . I, g=1 . . . q and the error number q denotes the number of errors Ekg, k=1 . . . I, g=1 . . . q. Specifically, the error is Ekg, k=1 . . . I, g=1 . . . q:
A first error Ekg, k=1 . . . I, g=1 is a deviation from a predefined weight of said piece good Wk, k=1 . . . I.
A second error Ekg, k=1 . . . I, g=2 is a deviation from a predefined dimensional accuracy of said piece good Wk, k=1 . . . I.
A third error Ekg, k=1 . . . I, g=3 is a deviation from a predefined size of said piece good Wk, k=1 . . . I.
A fourth error Ekg, k=1 . . . I, g=4 is a burr formation on said piece good Wk, k=1 . . . I.
A fifth error Ekg, k=1 . . . I, g=5 is a deviation from a predefined filling of the cavity 110 during the injection molding process.
A sixth error Ekg, k=1 . . . I, g=6 is a burn mark on said piece good Wk, k=1 . . . I.
A seventh error Ekg, k=1 . . . I, g=7 is a clogged cooling channel of the injection molding machine 1.
An eighth error Ekg, k=1 . . . I, g=8 is a defective heating tape of injection molding machine 1.
A ninth error Ekg, k=1 . . . I, g=9 is a defective back pressure valve of screw 100 of injection molding machine 1.
A tenth error Ekg, k=1 . . . I, g=10 is a clogging of the nozzle 101 of the injection molding machine 1.
An eleventh error Ekg, k=1 . . . I, g=11 is a fluctuation in the viscosity of the melt MT of the injection molding machine 1.

Preferably, the operator of the injection molding machine 1 performs the fifteenth process step M15. In this way, the operator can visually inspect a part Wk, k=1 . . . I produced in a cycle Zk, k=1 . . . I and determine whether said piece good Wk, k=1 . . . I is free of defects. The operator can also check the injection molding machine 1 and determine whether the injection molding machine 1 in the cycle Zk, k=1 . . . is free from defects. For this purpose, the injection molding machine 1 has additional sensor units and output units, not shown in the figure, in order to detect a blocked cooling channel or a defective heating tape or a defective pack pressure valve of the screw 100 or a blockage of the nozzle 101 or a fluctuation in the viscosity of the melt MT. If there is an anomaly AN in the manufacturing process, the operator determines the error Ekg, k=1 . . . I, g=1 . . . q. The operator generates error data EDkg, k=1 . . . I, g=1 . . . q for the determined error Ekg, k=1 . . . I, g=1 . . . q. The operator can enter the error data EDkg, k=1 . . . I, g=1 . . . q into the evaluation unit 14 via the input unit 143. The error data EDkg, k=1 . . . I, g=1 . . . q are digital data.

In a sixteenth process step M16, an error model EM is provided, which error model EM is trained with the error data EDkg, k=1 . . . I, g=1 . . . q. The error model EM determines an error class ECg, g=1 . . . q for each error index g of the error data EDkg, k=1 . . . I, g=1 . . . q. The error model EM is provided in the evaluation unit 14. To determine the error class ECg, g=1 . . . q, the computer program CP loaded into the data processor 140 causes the evaluation unit 14 to load the error model EM and the error data EDkg, k=1 . . . I, g=1 . . . q into the data processor 140 and to train the error model EM with the error data EDkg, k=1 . . . I, g=1 . . . q.

In a seventeenth process step M17, the sensor data XDkj, k=1 . . . I, j=1 . . . m of the manufacturing process of a piece good Wk, k=1 . . . I, which piece good Wk, k=1 . . . I has an error Ekg, k=1 . . . I, g=1 . . . q or the sensor data XDkj, k=1 . . . I, j=1 . . . m of the cycle Zk, k=1 . . . I of the injection molding machine 1, in which cycle Zk, k=1 . . . I the injection molding machine 1 has an error Ekg, k=1 . . . I, g=1 . . . q, is classified into the error class ECg, g=1 . . . q determined for the error Ekg, k=1 . . . I, g=1 . . . q as error sensor data EXDkjg, k=1 . . . I, j=1 . . . m, g=1 . . . q. The execution of the seventeenth process step M17 by the evaluation unit 14 is initiated by the computer program CP loaded into the data processor 140. The error sensor data EXDkjg, k=1 . . . I, j=1 . . . m, g=1 . . . q are also referred to as error sensor data EXD without cycle index k and without sensor data index j and without error index g.

In an eighteenth process step M18, at least one temporal sequence of additional sensor data XD′j, j=1 . . . m of the manufacturing process of a further piece good W′ on the injection molding machine 1 is provided for a further cycle Z′. The execution of the eighteenth process step M18 by the evaluation unit 14 is initiated by the computer program CP loaded into the data processor 140.

In a nineteenth process step M19, the additional sensor data XD′j, j=1 . . . m are entered into the error model EM. The error model EM determines whether the additional sensor data XD′j, j=1 . . . m can be classified into an error class ECg, g=1 . . . q. And if the additional sensor data XD′j, j=1 . . . m can be classified into an error class ECg, g=1 . . . q, error class information ECI′ is generated, which indicates the error class ECg, g=1 . . . q for the further piece good W′ or for the injection molding machine 1. The execution of the nineteenth process step M19 by the evaluation unit 14 is initiated by the computer program CP loaded into the data processor 140.

Preferably, the process information INF, the anomaly information ANI and the error class information ECI′ are output on the output unit 142 of the operator of the injection molding machine 1.

### LIST OF REFERENCE NUMERALS

1 Injection molding machine
10 Injection device
11 Injection mold
12 Control unit
13 Sensor unit
14 Evaluation unit
100 Screw
101 Nozzle
110 Cavity
140 Data processor
141 Data memory
142 Output unit
143 Input unit
AA Anomaly area
AN Anomaly
ANI Anomaly information
AMPD Abnormal machine setting data
APPD Abnormal process parameter data
CP Computer program
D Device
DD Density distribution
E Error
EC Error class
ECI Error class information
ED Error data
EM Error model
EXD Error sensor data
g Error index
GP Good part
h Process parameter index
i Machine setting parameter index
I Injection phase
II Holding pressure phase
III Residual cooling phase
INT Integral
INF Process information
j Sensor data index
k Cycle index
l Cycle number
m Sensor data number
M Method
M1 to M19 Process step
MLM Machine learning model
MP Machine setting parameter
MPD Machine setting data
MT Melt
MV Mean Value
n Machine setting parameter number
o Process parameter number
P Cavity pressure
PI Initial cavity pressure
PII Filling pressure
PIII Sealing point pressure
PD, PD′ Point data
Pmax Maximum cavity pressure
PP Process parameter
PPD Process parameter data
q Piece good error number
R Effect relationship
RE Residual
RM Regression model
SA Stability area
SI Sign
SMPD Stable machine setting data
SPPD Stable process parameter data
ST Stability
STD Stability confirmation data
SXD Stable Sensor data
SZ Size
t Time
tI Begin of the injection phase
tI Switchover time
tIII Sealing point
tIV End of the residual cooling phase
TD Threshold distance
W, W′ Piece good
XD, XD′ Sensor data
Y Cavity pressure curve
Z, Z Cycle

What is claimed is:

1. A computer-implemented method for monitoring a cyclic production process with several cycles, the method comprising:
receiving, by computing system, a temporal sequence of sensor data associated with a production machine performing the cyclic production process for at least one product during a first cycle, wherein a plurality of parameters of the production machine are set according to current machine setting data;
generating, by the computing system, production point data based on the temporal sequence of sensor data associated with an injection mold machine performing the cyclic production process of at least one product during a first cycle;
comparing, by the computing system, the production point data to a mean value of stability to generate a stability value for the first cycle, wherein the mean value of stability is determined based on an evaluation of previous cycles of the cyclic production process and a stability value represents a likelihood of errors in the at least one product produced during the first cycle; and
in accordance with a determination that the stability value does not exceed a threshold stability value, transmitting instructions to update at least one setting parameter of the production machine before performing a second cycle of the cyclic production process.

2. The computer-implemented method of claim 1, wherein the sensor data is produced by a pressure sensor included in the production machine.

3. The computer-implemented method of claim 1, wherein production point data is generated using a machine-learned model.

4. The computer-implemented method of claim 3, wherein the machine-learned model is trained using training data labeled based on an inspection of the products produced by one or more previous production cycles and the sensor data associated with the one or more previous cycles.

5. The computer-implemented method of claim 4, wherein the training data labeled based on an inspection of the products produced by the previous production cycle includes process parameter data for each previous production cycle.

6. The computer-implemented method of claim 5, wherein the process parameter data describes one or more attributes of a production cycle including one or more of a maximum cavity pressure, an integral of a cavity pressure curve, and point data.

7. The computer-implemented method of claim 6, the method further comprising:
providing, by the computing system, the current machine setting data and the process parameter data to a machine-learned model as input; and
receiving, by the computing system, model output from the machine-learned model, wherein the model input includes an effect relationship between the current machine setting data and the process parameter data.

8. The computer-implemented method of claim 7, wherein transmitting instructions to update at least one setting parameter of the production machine before performing a second cycle of the cyclic production process further comprises:
determining, by the computing system, based on the current process parameter data and the effect relationship between the current machine setting data and the process parameter data, at least one planned setting parameter change.

9. The computer-implemented method of claim 8, further comprising:
in accordance with a determination that the stability value does not exceed a threshold stability value, providing, by the computing system, current process parameter data to an error determining model; and
receiving, by the computing system as output from the error determining model, an error class associated with the first cycle.

10. The computer-implemented method of claim 4, wherein the training data further comprises temporal sequences of sensor data previously designated as stable and temporal sequences of sensor data designated as anomalous.

11. The computer-implemented method of claim 10, further comprising:
generating, by the computing system, stability point data for the temporal sequences of data previously designated as stable by dimensionally reducing temporal sequences of database previously designated as stable;
generating, by the computing system, a density distribution of the stability point data; and
performing, by the computing system, a statistical analysis of the stability point data to determine a mean value of stability.

12. The computer-implemented method of claim 11, wherein comparing, by the computing system, the production point data to a mean value of stability to generate a stability value for the first cycle comprises:
calculating, by the computing system, a distance between the production point data and the mean value of stability; and
generating, by the computing system, the stability value based on the distance between the production point data and the mean value of stability.

13. The computer-implemented method of claim 1, wherein the production machine is an injection molding machine and the cyclic production process is an injection modeling process in which products are produced in cycles.

14. The computer-implemented method of claim 13, wherein the injection molding machine comprising at least one injection device with a screw and at least one injection mold with at least one cavity.

15. The computer-implemented method of claim 14, wherein the injection molding comprises an injection phase, a holding pressure phase, and a residual cooling phase.

16. The computer-implemented method of claim 15, wherein the at least one setting parameter comprises one of: a metering speed of the screw of an injection device, an injection speed of a melt into the cavity of the injection mold, a switchover time from the injection phase to the holding pressure phase, a relief movement of the screw of the injection device, a setpoint value of the holding pressure in the holding pressure phase, a temperature of the melt, and a temperature of the injection mold.

17. The computer-implemented method of claim 1, the method further comprising:
determining, by the computing system, a cavity pressure curve based on the temporal sequence of sensor data associated with a production machine performing the cyclic production process of at least one product during a first cycle.

18. A computing system, the computing system comprising:
one or more processors; and
a computer-readable memory, wherein the computer-readable memory stores instructions that, when executed by the one or more processors, cause the computing system to perform operations, the operations comprising:
receiving a temporal sequence of sensor data associated with a production machine performing the cyclic production process for at least one product during a first cycle, wherein a plurality of parameters of the production machine are set according to current machine setting data;
generating production point data based on the temporal sequence of sensor data associated with an injection mold machine performing the cyclic production process of at least one product during a first cycle;
comparing the production point data to a mean value of stability to generate a stability value for the first cycle, wherein the mean value of stability is determined based on an evaluation of previous cycles of the cyclic production; and
in accordance with a determination that the stability value does not exceed a threshold stability value, transmitting instructions to update at least one setting parameter of the production machine before performing a second cycle of the cyclic production process.

19. A non-transitory computer-readable medium storing instructions that, when executed by one or more computing systems, cause the one or more computing systems to perform operations, the operations comprising:
receiving a temporal sequence of sensor data associated with a production machine performing a cyclic production process for at least one product during a first cycle, wherein a plurality of parameters of the production machine are set according to current machine setting data;
generating production point data based on the temporal sequence of sensor data associated with an injection mold machine performing the cyclic production process of at least one product during a first cycle;
comparing the production point data to a mean value of stability to generate a stability value for the first cycle, wherein the mean value of stability is determined based on an evaluation of previous cycles of the cyclic production process; and
in accordance with a determination that the stability value does not exceed a threshold stability value, transmitting instructions to update at least one setting parameter of the production machine before performing a second cycle of the cyclic production process.
